(19) United States
(12) Patent Application Publication
(10) Pub. No.: US 2026/0089608 A1
(43) Pub. Date: Mar. 26, 2026

(54) ENHANCING THE DISCOVERABILITY OF FREQUENCY-SPECIFIC ACCESS POINTS WITHIN A WIRELESS LOCAL AREA NETWORK

(71) Applicant: Cypress Semiconductor Corporation, San Jose, CA (US)

(72) Inventor: Yi-Chuan Chen, ChuPei City (TW)

(73) Assignee: Cypress Semiconductor Corporation, San Jose, CA (US)

(21) Appl. No.: 18/898,392

(22) Filed: Sep. 26, 2024

(51) Int. Cl. H04W 48/08; H04W 84/12

(52) U.S. Cl. CPC H04W 48/08; H04W 84/12

(57) ABSTRACT

A wireless network access device includes a wireless local area network (WLAN) radio, a memory device that stores instructions, and a processing device operatively coupled to the memory device and WLAN radio. The WLAN radio is configured to transmit and receive on a first frequency band, a second frequency band, and a third frequency band. The processing device is configured to execute the instructions to send a signal on the first frequency band and the second frequency band to a first neighboring access point (AP), the signal causing the first neighboring AP to update a reduced neighbor report information element (RNR IE) of a transmission to include information associated with the wireless network access device; and connect to a wireless device on the third frequency band responsive to the wireless device receiving an updated transmission from the first neighboring AP, the updated transmission having an RNR IE including the information.

### TECHNICAL FIELD

Aspects and embodiments of the disclosure relate to wireless local area networks, and more specifically, to devices and methods for enhancing the discoverability of frequency-specific access points within a wireless local area network

### BACKGROUND

A wireless device may communicate over a wireless local area network (WLAN). The wireless device may only be able to connect to a WLAN via an access point. Access points may only communicate within a specific gigahertz (GHz) frequency band.

### BRIEF DESCRIPTION OF THE DRAWINGS

Aspects and implementations of the present disclosure will be understood more fully from the detailed description given below and from the accompanying drawings of various aspects and implementations of the disclosure, which, however, should not be taken to limit the disclosure to the specific aspects or implementations, but are for explanation and understanding only.

FIG. 1A is a block diagram of an example system architecture, in accordance with some implementations of the disclosure.

FIG. 1B is a block diagram of an example of transmissions in a wireless network, in accordance with some implementations of the disclosure

FIGS. 2A-B illustrate examples of a signal, in accordance with some implementations of the disclosure.

FIG. 3 is a flow diagram of an example method associated with enhancing the discoverability of a wireless access point, in accordance with some implementations of the disclosure.

FIG. 4 is a flow diagram of an example method associated with enhancing the discoverability of a wireless access point, in accordance with some implementations of the disclosure.

FIG. 5 is a block diagram illustrating an example of a computer system, in accordance with some implementations of the disclosure.

### DETAILED DESCRIPTION

Aspects of the present disclosure relate to devices and methods for enhancing the discoverability of frequency-specific access points within a wireless local area network. Wireless devices may communicate (e.g., connect with other wireless devices or the Internet) through various wireless media, including a wireless local area network (WLAN). A WLAN is a network that allows devices to connect and communicate wirelessly within a limited area (e.g., a home, an office, a school campus, etc.) via radio waves. These radio waves are measured in gigahertz (GHz) and are grouped into bands. The most common bands are the 2.4 GHz and 5 GHz frequency bands. However, there is a strong desire for more connectivity with the newer 6 GHz band because it offers very high data rates and low latency with minimal interference when compared to the 2.4 GHz and 5 GHz bands. This desire will likely continue to apply as higher frequency bands are made available to the public. These frequency bands are allotted and regulated by the Federal Communications Commission (FCC) of the United States, which manages the radio frequency spectrum and allots various frequencies to various uses.

In order for a wireless device (e.g., a user device such as a smartphone, tablet, or personal computer) to connect with and communicate on the WLAN, it must first connect with an access point. An access point (AP) is a hardware device that allows wireless devices with connection capability to connect to a wired network by creating a WLAN.

In order to connect with an AP, a wireless device must be notified that the AP exists. This can be done in a number of ways. One way is for the AP to transmit a beacon frame. A beacon frame is a type of management frame that is periodically sent by the AP to announce the presence of a WLAN and be discovered by a wireless device. This is a passive method which allows a wireless device within range of the AP to receive and process the beacon frame in order to detect the corresponding WLAN.

Another way for a wireless device to find an AP and WLAN is through an active method involving a probe request and response. A probe request is sent by the wireless device to discover available APs and WLANs in the area. When an AP receives a probe request, it will respond with a probe response that contains information about the AP. This information is similar to the information provided in a beacon frame and allows the wireless device to discover the AP.

In addition to information about the AP, the beacon frame or probe response may also include information about other APs within the area. This information is stored in a reduced neighbor report information element (RNR IE). When an AP transmits an RNR IE back to a wireless device, the wireless device will then have information about the AP that sent the transmission as well as the APs in the surrounding area.

Conventionally, APs may only communicate within a specific gigahertz (GHz) frequency band. This means that if an AP is built to communicate within the 2.4 GHz band, it may not send or receive transmissions on the 5 GHz or 6 GHz bands. While conventional APs have some dual-band functionality on lower frequency bands (i.e., may operate on the 2.4 GHz and 5 GHz bands), a conventional 6 GHz-only AP (e.g., an AP configured to operate only within the 6 GHz frequency band) is limited to communicating only on the 6 GHz frequency band. This makes it difficult for wireless devices with the ability to communicate on the 6 GHz frequency band to find an AP on the 6 GHz frequency band because the AP on the 6 GHz band is unable to share its information with neighboring APs for the RNR IE to be updated.

Conventionally, an RNR IE is limited to APs within the same extended service set (ESS), which is essentially a group of APs that are in a co-located AP (e.g., the group of APs are part of the same physical device) and do not necessarily have to have the same service set identifier (SSID). The SSID is the name assigned to a WLAN and is used to identify the WLAN. This means that, when a wireless device is searching for an AP and WLAN to connect to, the results it receives may be limited to APs within the same network, even when responses include an RNR IE. This makes it difficult for a wireless device to discover a WLAN which is either hidden or has not been discovered before.

In addition to this problem, conventional 6 GHz-only APs are often limited to sharing information about requested preferred scanning channels (PSCs) when operating within the 6 GHz frequency band. These PSCs are preselected to make discovery and connection faster and more efficient. However, not all wireless devices have the capability of scanning for and requesting PSCs, so they are simply left out of RNR IEs. This means that a device without active PSC scanning capability will not be able to find 6 GHz-only APs communicating within the 6 GHz frequency band, resulting in having to communicate on a frequency band that is slower and less efficient.

Aspects and embodiments of the present disclosure overcome these problems and others by enhancing the discoverability of frequency-specific APs within a wireless local area network. Aspects and embodiments of the present disclosure can enhance discoverability by sending a signal to one or more neighboring APs on a first frequency band and a second frequency band, which contains instructions to update and RNR IE with information to make the wireless network access device of the present disclosure discoverable on a third frequency band.

In some embodiments, a wireless network access device (e.g., AP) may include a WLAN radio configured to transmit and receive on a first frequency band, a second frequency band, and a third frequency band. The wireless network access device may further include a memory device that stores instructions and a processing device operatively coupled to the memory device and WLAN radio. The processing device may be configured to execute the instructions to send a signal on the first frequency band and the second frequency band to a first neighboring AP, the signal causing the first neighboring AP to update an RNR IE of a transmission to include information associated with the wireless network access device. The processing device may be configured to further execute the instructions to connect to a wireless device on the third frequency band responsive to the wireless device receiving an updated transmission from the first neighboring AP, the updated transmission having an RNR IE including the information. In some embodiments, the information may include a public action frame having an operating class, an operating channel, a basic service set identifier (BSSID), and/or a service set identifier (SSID). In some embodiments, the first frequency band may correspond to the 2.4 GHz frequency band, the second frequency band may correspond to the 5 GHz frequency band, and the third frequency band may correspond to the 6 GHz frequency band.

The systems, devices, and methods disclosed herein have technical advantages over conventional solutions. In some embodiments, the present disclosure may communicate on more than just the 6 GHz frequency band. In some embodiments, the present disclosure may allow the RNR IE of an AP to be updated outside of that AP's ESS and SSID. In some embodiments, the present disclosure may enable APs to share information outside of the PSCs within the 6 GHz frequency band.

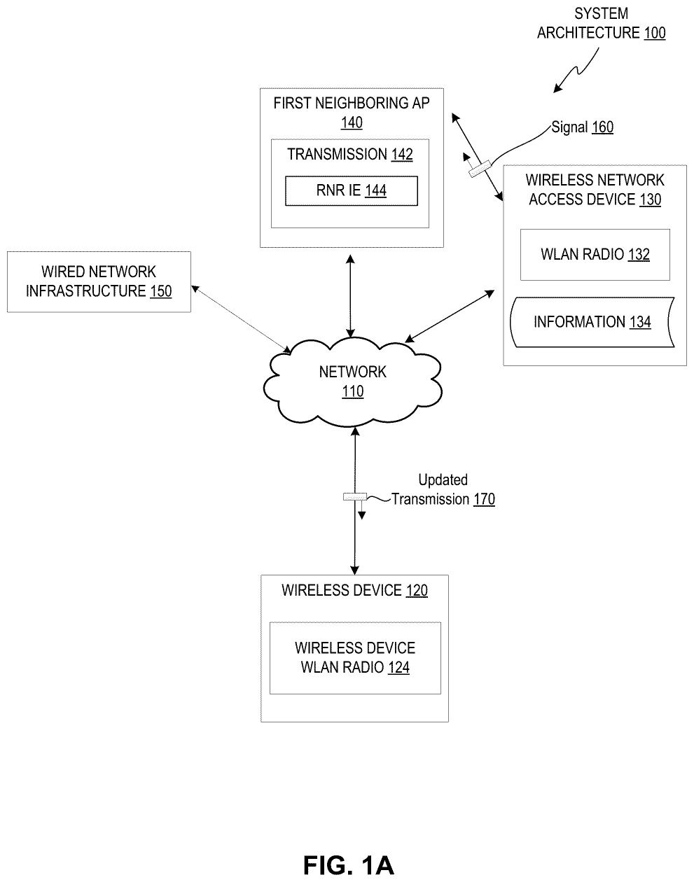

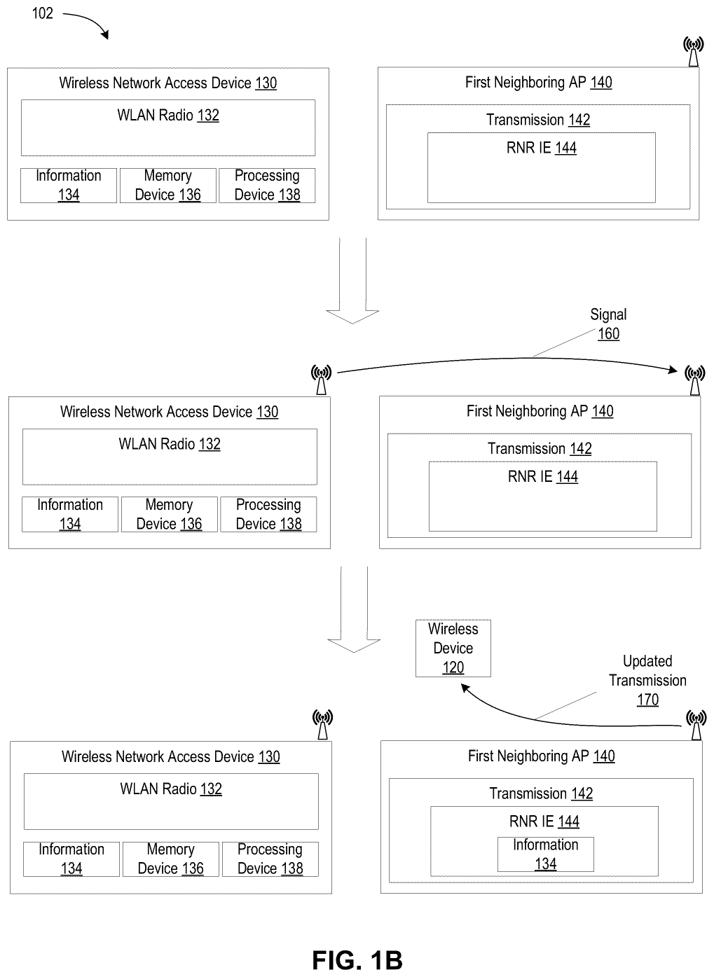

FIG. 1 is a block diagram of an example system architecture 100, in accordance with some embodiments of the disclosure. The system architecture 100 may include a network 110, a wireless device 120, a wireless network access device 130, a first neighboring AP 140, and a wired network infrastructure 150.

Network 110 may be a public network that provides a wireless device 120 with access to the wired network infrastructure 150 and other publicly available computing devices. Network 110 may include one or more wide area networks (WANs), local area networks (LANs), wired networks (e.g., Ethernet network), wireless networks (e.g., an 802.11 network or a wireless local area network (WLAN)), cellular networks (e.g., a Long Term Evolution (LTE) network), routers, hubs, switches, server computers, and/or a combination thereof.

Wireless device 120 may include computing devices such as personal computers (PCs), laptops, mobile phones, smart phones, tablet computers, netbook computers, network-connected televisions, etc. Wireless device 120 may be capable of interacting with the wireless network access device 130 and/or the first neighboring AP 140. Wireless device 120 may also be capable of receiving an updated transmission 170 from the first neighboring AP 140. Wireless device 120 may also include a wireless device WLAN radio 124, which may be capable of receiving and transmitting signals wirelessly via the network 110.

The wireless network access device 130 may be another AP (e.g., a wireless AP). In some embodiments, the wireless network access device 130 may be a wireless device (e.g., a wireless phone, smartphone, wireless table, personal computer, etc.). The wireless network access device 130 may further include a memory device and a processing device, which will be discussed further in connection with FIG. 1B.

The wireless network access device 130 may include a WLAN radio 132. The WLAN radio 132 may be responsible for handling wireless communication over the network 110. In some embodiments, the WLAN radio 132 may comprise various subcomponents, including one or more of an antenna, transmitted, receiver, modulator/demodulator (modem), radio frequency amplifier, bandpass filter, oscillator, digital signal processor, power amplifier, control logic, and/or network interface, according to certain embodiments. In some embodiments, these and other subcomponents may allow the WLAN radio 132 to facilitate wireless communication over a network.

The wireless network access device 130 may further include information 134 associated with the wireless network access device 130. In some embodiments, this information 134 may be included in a signal 160 to be transmitted to the first neighboring AP 140. The information 134 may then be used to update an RNR IE 144 of a transmission 142 of the first neighboring AP 140. The signal 160 may be a radio frequency (RF) signal, which is one or more of a modulated electromagnetic wave that carries digital data from the wireless network access device 130 to the first neighboring AP 140. In some embodiments, the signal 160 may be sent (e.g., transmitted as a unicast or multicast) on the first frequency band and/or the second frequency band.

The first neighboring AP 140 may be a device that acts as a central hub for wireless communication for connecting wireless devices. The first neighboring AP 140 may broadcast a wireless signal that devices can use to connect to the first neighboring AP 140, allowing the devices to communicate with each other and access resources on the network 110 (e.g., a wired network, a wireless network, the Internet, or any combination thereof). It should be noted that the first neighboring AP 140 may be a software AP (Soft AP) or a hardware AP (dedicated device AP). Both are used to enable wireless connectivity, but they differ in their implementation and use cases. In general, a Soft AP is created using software on a device that normally functions as a client. The device's wireless adapter is configured to act or function as an AP (i.e., the Soft AP). A hardware AP is a dedicated device specifically designed to as an AP, including specialized hardware (i.e., antennas, radios, and network interfaces). The first neighboring AP 140 can be a hardware AP (i.e., an AP device) or a Soft AP. The first neighboring AP 140 may also be one of one or more neighboring APs.

The first neighboring AP 140 may act as a bridge between the wireless device 120 and a wired network infrastructure 150 to facilitate connection between the wireless device 120 and the network 110. The first neighboring AP 140 may be a single AP in certain embodiments, or may be a set of one or more APs that share the same service set identifier (SSID) in some embodiments.

FIG. 1B is a block diagram of an example of transmissions in a wireless network 102, in accordance with some implementations of the disclosure The wireless network 102 may include a wireless network access device 130 and a first neighboring AP 140. Elements with common numbering between FIGS. 1A-B may have similar functionalities and/or properties.

The wireless network access device 130 may include a WLAN radio 132, information 134, a memory device 136, and a processing device 138. The memory device 136 may be used for storing data, instructions, and/or temporary information required during operating of the wireless network access device 130. The memory device 136 may include random access memory (RAM) and/or read-only memory (ROM). The processing device 138 may be coupled to the memory device 136 in some embodiments to execute instructions stored on the memory device 136. The processing device 138 may be operatively coupled to the WLAN radio 132 to execute instructions. In some embodiments, the memory device 136 and the processing device 138 may be subcomponents of the WLAN radio 132.

The first neighboring AP 140 may transmit a transmission 142 having an RNR IE 144. The transmission 142 may be a beacon frame or a probe response. The beacon frame may be a type of management frame sent periodically by the first neighboring AP 140 to announce the presence of a wireless network and provide information to the wireless network access device 130. In some embodiments, the beacon frame may be broadcast by the first neighboring AP 140 at regular intervals (e.g., every 100 milliseconds) and may be received by any wireless device 120 within range.

In some embodiments, the transmission 142 may also broadcast a probe response. The probe response may be a type of management frame sent by the first neighboring AP 140 in response to the first neighboring AP 140 receiving a probe request from a wireless device 120 on the first frequency band or the second frequency band. The probe response may, in some embodiments, provide information to the wireless device 120 about the wireless network, the wireless network access device 130, and/or the first neighboring AP 140.

The transmission 142 may contain a reduced neighbor report information element (RNR IE) 144 as part of the updated transmission 170 transmitted to the wireless device 120, according to certain embodiments. The RNR IE 144 may enhance the efficiency of network discovery and roaming by providing information about the wireless network access device 130. The RNR IE 144 may be updated in response to the first neighboring AP 140 receiving the signal 160 from the wireless network access device 130. In some embodiments, updating the RNR IE 144 may allow for increased discoverability of the wireless network access device 130 at a third frequency band (e.g., 6 GHz). The updated RNR IE 144 may be broadcast to the wireless device 120 via the updated transmission 170. In some embodiments, the wireless device 120 may be able to connect with the wireless network access device 130 and communicate on the third frequency band responsive to receiving the updated RNR IE 144 via the updated transmission 170 from the first neighboring AP 140.

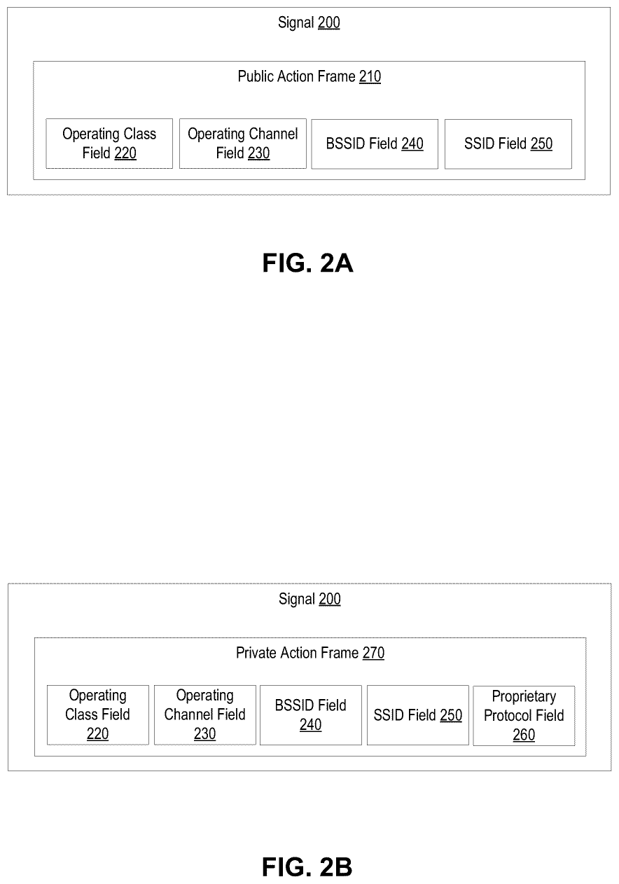

FIGS. 2A-2B illustrate examples of a signal, in accordance with some implementations of the disclosure. FIG. 2A is an example of a signal without a proprietary protocol, and FIG. 2B is an example of a signal with a proprietary protocol. Elements with common numbering between FIGS. 2A-B may have similar functionalities and/or properties.

FIG. 2A is an example of a signal 200, in accordance with some implementations of the disclosure. The signal 200 substantially corresponds to the signal discussed in conjunction with FIG. 1A (e.g., the signal 160 of FIG. 1A). The signal 200 may include a public action frame 210, according to certain embodiments.

The public action frame 210 may be a type of management frame to facilitate communication between one or more devices. The one or more devices may include the wireless network access device of FIG. 1A (e.g., the wireless network access device 130 of FIG. 1A) and the first neighboring AP of FIG. 1A (e.g., the first neighboring AP 140 of FIG. 1A). The one or more devices may be on the same wireless network (e.g., the wireless network 110 of FIG. 1A), on different wireless networks, or not yet fully associated with a wireless network.

The public action frame 210 may include one or more fields, and may indicate a public action type (e.g., a specific category or classification of action to be performed by the public action frame 210). The one or more fields contain information related to the wireless network access device and the signal 200. The one or more fields may include an operating class field 220, an operating channel field 230, a basic service set identifier (BSSID) field 240, and/or an SSID field 250.

The operating class field 220 may provide information about the specific regulatory environment and channelization being used by the signal 200, according to certain embodiments. The operating class field 220 may contain information necessary to interpret channel-related data within the public action frame 210. In some embodiments, the operating class field 220 may have a value of 172, 174, 175, or 176 which corresponds to a frequency band of 6 GHz in the United States. In some embodiments, the operating class field 220 may have another value corresponding to the frequency band of 6 GHz. In some embodiments, the operating class field 220 may have another value corresponding to a different frequency band (e.g., a band with a frequency greater than 6 GHz).

The operating channel field 230 may provide a specific frequency band or channel that the one or more devices intends to use for communication. In some embodiments, the specific frequency band or channel corresponds to the third frequency band (e.g., 6 GHz), but may correspond to other frequency bands with a greater frequency value. The operating channel field 230 may provide a channel number within a range from 1 to about 233 corresponding to the 6 GHz frequency band. In some embodiments, the operating channel field 230 may provide a channel number greater than 233 corresponding to a frequency band greater than the 6 GHz frequency band. The channel width of a given operating channel number corresponds to a range of frequencies the channel occupies within a given frequency band. In some embodiments, the operating channel field 230 may correspond to a channel number with a channel width of 20 MHz, 40 MHz, 80 MHz, or 160 MHz. In some embodiments, the channel width may be indicated by the operating class field 220, which may also indicate a channel set. The channel number may indicate a channel which is one of the channel set. In some embodiments, the operating class field 220 and the operating channel field 230 may correspond to a channel number with a different channel width.

The BSSID field 240 may correspond to the BSSID of the wireless device, which identifies the wireless device specifically within a basic service set (BSS). In some embodiments, the BSSID may be a unique media access control (MAC) address assigned to the wireless device.

The SSID field 250 may correspond to the SSID of the wireless network (e.g., the network 110 of FIG. 1A) to which the wireless device is connected. In some embodiments, the SSID field 250, when transmitted to the one or more devices via the signal 200, may allow the one or more devices to identify the wireless network.

In some embodiments, the public action frame 210 and the various frames contained therein may be used to update an RNR IE (e.g., the RNR IE 144 of FIG. 1A) in a transmission (e.g., the transmission 142 of FIG. 1A) of the first neighboring AP 140. When the RNR IE of the transmission is updated, it does so by incorporating the information (e.g., the information 134 of FIG. 1A) contained within the public action frame 210. By incorporating the information contained in the public action frame 210 from the signal 200, the first neighboring AP 140 may notify other neighboring APs of the wireless network access device transmitting the signal 200. This may improve the discoverability of the wireless network access device in some embodiments.

FIG. 2B is an example of a signal 200, in accordance with some implementations of the disclosure. The signal 200 is substantially similar to the signal 200 of FIG. 2A. The wireless signal 200 may include a private action frame 270 that includes one or more fields. In addition to the fields described in conjunction with FIG. 2A, the fields of the private action frame 270 may further include a proprietary protocol field 260.

The proprietary protocol field 260 may carry vendor or technology specific information relating to the wireless network access device (e.g., the wireless network access device 130 of FIG. 1A) indicated by a vendor specific organizationally unique identifier (OUI) field. This may allow for private network management protocols to be shared publicly with neighboring APs via the updated RNR IE and enhance discoverability of these private networks.

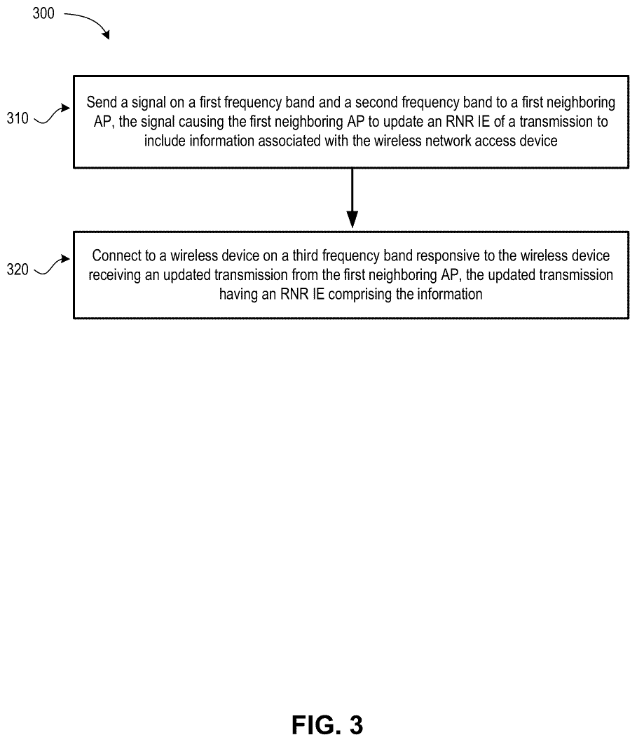

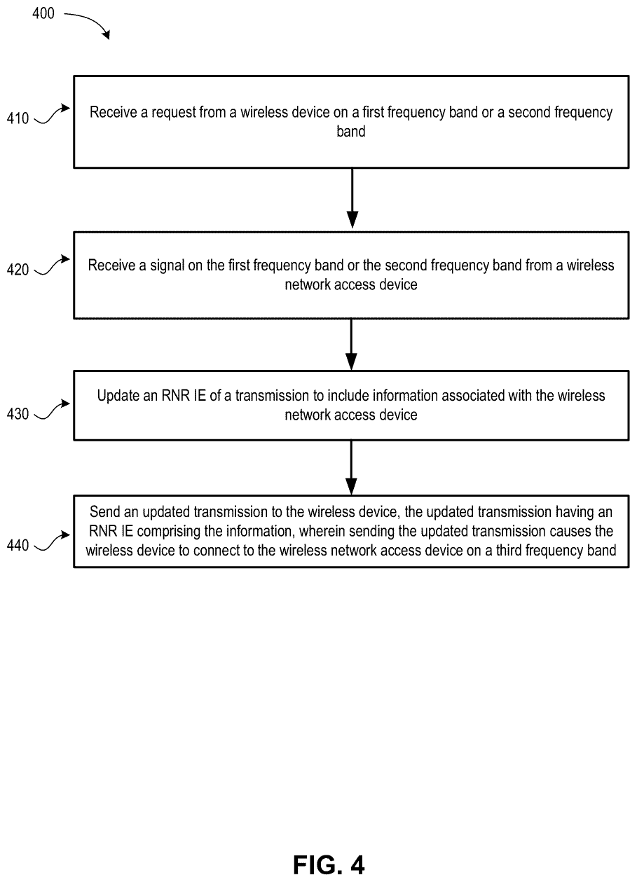

FIGS. 3-4 depict flow diagrams of example methods 300-400 for enhancing the discoverability of a wireless AP, in accordance with some implementations of the disclosure. Methods 300 and/or 400 and/or each of the aforementioned method's individual functions, routines, subroutines, or operations may be performed by a processing device, having one or more processing units (CPU) and memory devices communicatively coupled to the CPU(s). In some embodiments, methods 300 and/or 400 may be performed by a single processing thread or alternatively by two or more processing threads, each thread executing one or more individual functions, routines, subroutines, or operations of the method. Methods 300 and/or 400 as described below may be performed by processing logic that may include hardware (e.g., processing device, circuitry, dedicated logic, programmable logic, microcode, hardware of a device, integrated circuit, etc.), software (e.g., instructions run or executed on a processing device), or a combination thereof.

In some embodiments, methods 300 and/or 400 may be performed by a wireless network access device 130 and/or a first neighboring AP 140 as described in conjunction with FIG. 1A. Although shown in a particular sequence or order, unless otherwise specified, the order of the operations may be modified. Thus, the illustrated embodiments should be understood only as examples, and the illustrated operations may be performed in a different order, while some operations may be performed in parallel. Additionally, one or more operations may be omitted in some embodiments. Thus, not all illustrated operations are required in every embodiment, and other process flows are possible. In some embodiments, the same, different, fewer, or greater operations may be performed. It may be noted that elements of FIGS. 1A-B and 2A-B may be used herein to help describe FIGS. 3-4.

FIG. 3 is a flow diagram of an example method 300 associated with enhancing the discoverability of a wireless AP, in accordance with some implementations of the disclosure. Method 300 may be performed by processing logic comprising hardware, firmware, or any combination thereof. Method 300 may be performed by a wireless network access device 130 of FIG. 1A and/or a first neighboring AP 140 of FIG. 1A.

At operation 310 of method 300, a processing device may instruct the wireless network access device to send a signal on a first frequency band and a second frequency band to a first neighboring AP (e.g., the first neighboring AP 140 of FIG. 1A), the signal causing the first neighboring AP 140 to update an RNR IE of a transmission to include information associated with the wireless network access device (e.g., the wireless network access device 130 of FIG. 1A). In some embodiments, the first frequency band may correspond to the 2.4 GHz frequency band used in wireless communication. The 2.4 GHz frequency band may span from about 2.400 GHz to about 2.4835 GHz. In some embodiments, the second frequency band may correspond to the 5 GHz frequency band used in wireless communication. The 5 GHz frequency band may span from about 5.150 GHz to about 5.825 GHz.

At operation 320 of method 300, the processing device may instruct the wireless device to connect to a wireless device (e.g., the wireless device 120 of FIG. 1A) on a third frequency band responsive to the wireless device receiving an updated transmission from the first neighboring AP, the updated transmission having an RNR IE comprising the information. This information may include a public action frame, which may include various subcomponents. In some embodiments, the various subcomponents may include an operating class field, an operating channel field, a BSSID field, and/or a SSID field. In some embodiments, the third frequency band may correspond to the 6 GHz frequency band used in wireless communication. The 6 GHz frequency band may span from about 5.925 GHz to about 7.125 GHz. In some embodiments, the third frequency band may correspond to a frequency band spanning frequencies larger than 7.125 GHz. The third frequency band of operation may contain frequencies larger than those contained in the first frequency band and second frequency band of operation 310.

FIG. 4 is a flow diagram of an example method 400 associated with enhancing the discoverability of a wireless AP, in accordance with some implementations of the disclosure. Method 400 may be performed by processing logic comprising hardware, firmware, or any combination thereof. Method 400 may be performed by a wireless network access device 130 of FIG. 1A and/or a first neighboring AP 140 of FIG. 1A.

At operation 410 of method 400, a first neighboring AP (e.g., the first neighboring AP 140 of FIG. 1A), may be configured to receive a request from a wireless device (e.g., the wireless device 120 of FIG. 1A) on a first frequency band or a second frequency band. In some embodiments, the first frequency band may correspond to the 2.4 GHz frequency band used in wireless communication. The 2.4 GHz frequency band may span from about 2.400 GHz to about 2.4835 GHz. In some embodiments, the second frequency band may correspond to the 5 GHz frequency band used in wireless communication. The 5 GHz frequency band may span from about 5.150 GHz to about 5.825 GHz.

At operation 420 of method 400, the first neighboring AP may be configured to receive a signal on the first frequency band or the second frequency band from a wireless network access device (e.g., the wireless network access device 130 of FIG. 1A).

At operation 430 of method 400, the first neighboring AP may be configured to update an RNR IE of a transmission to include information associated with the wireless network access device. In some embodiments, the transmission may be a beacon frame and/or a probe response.

At operation 440 of method 400, the first neighboring AP may be configured to send an updated transmission to the wireless device, the updated transmission having an RNR IE comprising the information, wherein sending the updated transmission causes the wireless device to connect to the wireless network access device on a third frequency. In some embodiments, the third frequency band may correspond to the 6 GHz frequency band used in wireless communication. The 6 GHz frequency band may span from about 5.925 GHz to about 7.125 GHz. In some embodiments, the third frequency band may correspond to a frequency band spanning frequencies larger than 7.125 GHz. The third frequency band of operation may contain frequencies larger than those contained in the first frequency band and second frequency band of operations 410 and 420.

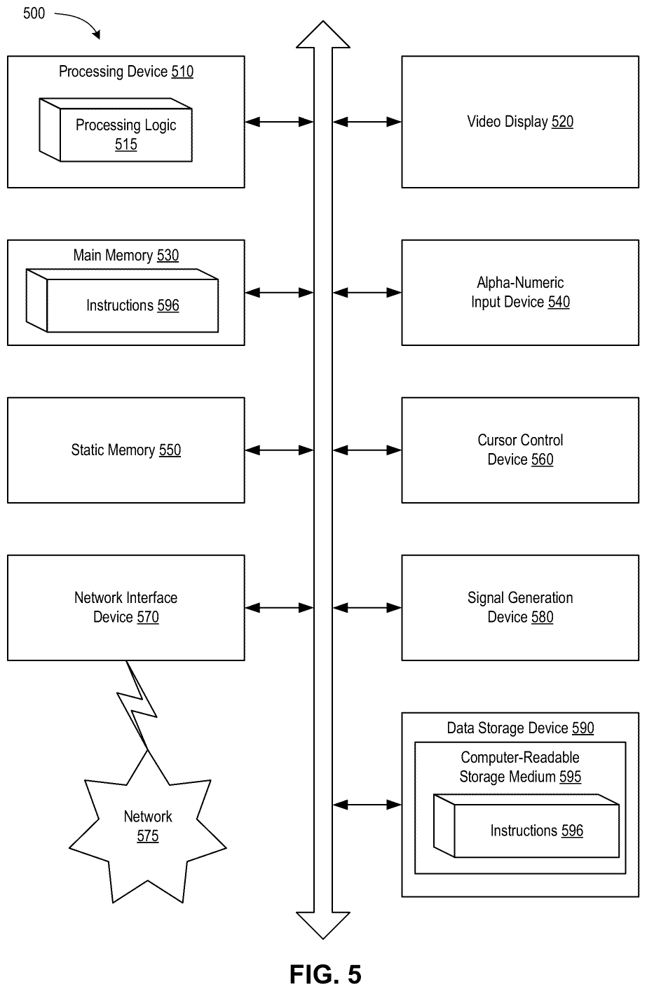

FIG. 5 is a block diagram illustrating an example of a computer device 500, in accordance with some implementations of the disclosure. Example computer device 500 may be connected to other computer devices in a LAN, an intranet, an extranet, and/or the Internet. Computer device 500 may operate in the capacity of a server in a client-server network environment. Computer device 500 may be a desktop computer, a laptop computer, a smartphone, a tablet, a table computer, a local server, a cloud server, a dedicated video processing server, a collection of multiple computing devices, a distributed computing system, a smart TV, an augmented reality device, or any other suitable computing device (or collection of computing devices) capable of performing the techniques described herein. Further, while only a single example computer device is illustrated, the term “computer” shall also be taken to include any collection of computers that individually or jointly execute a set (or multiple sets) of instructions to perform any one or more of the methods discussed herein.

Example computer device 500 may include a processing device 510 (also referred to as a processor or CPU), a main memory 530 (e.g., read-only memory (ROM), flash memory, dynamic random access memory (DRAM) such as synchronous DRAM (SDRAM), etc.), a static memory 550 (e.g., flash memory, static random access memory (SRAM), etc.), and a secondary memory (e.g., a data storage device), which may communicate with each other via a bus.

Processing device 510 (which may include processing logic 515) represents one or more general-purpose processing devices such as a microprocessor, central processing unit, or the like. More particularly, processing device 510 may be a complex instruction set computing (CISC) microprocessor, reduced instruction set computing (RISC) microprocessor, very long instruction word (VLIW) microprocessor, processor implementing other instruction sets, or processors implementing a combination of instruction sets. Processing device 510 may also be one or more special-purpose processing devices such as an application specific integrated circuit (ASIC), a field programmable gate array (FPGA), a digital signal processor (DSP), network processor, or the like.

Example computer device 500 may further comprise a network interface device 570, which may be communicatively coupled to a network 575. Example computer device 500 may further comprise a video display 520 (e.g., a liquid crystal display (LCD), a touch screen, or a cathode ray tube (CRT)), an alpha-numeric input device 540 (e.g., a keyboard), a cursor control device 560 (e.g., a mouse), and an acoustic signal generation device 580 (e.g., a speaker).

Data storage device 590 may include a computer-readable storage medium 595 (or, more specifically, a non-transitory computer-readable storage medium) on which is stored one or more sets of executable instructions 596.

Executable instructions 596 may also reside, completely or at least partially, within main memory 530 and/or within processing device 510 during execution thereof by example computer device 500, main memory 530, and processing device 510 also constituting computer-readable storage media. Executable instructions 596 may further be transmitted or received over a network 575 via network interface device 570.

While the computer-readable storage medium 595 is shown in FIG. 5 as a single medium, the term “computer-readable storage medium” should be taken to include a single medium or multiple media (e.g., a centralized or distributed database, and/or associated caches and servers) that store the one or more sets of operating instructions. The term “computer-readable storage medium” shall also be taken to include any medium that is capable of storing or encoding a set of instructions for execution by the machine that cause the machine to perform any one or more of the methods described herein. The term “computer-readable storage medium” shall accordingly be taken to include, but not be limited to, solid-state memories, and optical and magnetic media.

In the foregoing description, numerous details are set forth. It will be apparent, however, to one of ordinary skill in the art having the benefit of this disclosure, that the disclosure may be practiced without these specific details. In some instances, well-known structures and devices are shown in block diagram form, rather than in detail, in order to avoid obscuring the disclosure.

Unless specifically stated otherwise, it is appreciated that throughout the description, discussions utilizing terms such as “sending”, “receiving”, “broadcasting”, “identifying”, “determining”, “transmitting”, “updating” or the like, refer to the actions and processes of a computer system, or similar electronic computing device, that manipulates and transforms data represented as physical (e.g., electronic) quantities within the computer system memories or registers into other data similarly represented as physical quantities within the computer system memories or registers or other such information storage, transmission or display devices.

The disclosure also relates to an apparatus for performing the operations herein. This apparatus may be specially constructed for the required purposes, or it may include a general purpose computer selectively activated or reconfigured by a computer program stored in the computer. Such a computer program may be stored in a computer readable storage medium, such as, but not limited to, any type of disk including a floppy disk, an optical disk, a compact disc read-only memory (CD-ROM), a magnetic-optical disk, a read-only memory (ROM), a random access memory (RAM), an erasable programmable read-only memory (EPROM), an electrically erasable programmable read-only memory (EEPROM), a magnetic or optical card, or any type of media suitable for storing electronic instructions.

The word “example” is used herein to mean serving as an example, instance, or illustration. Any aspect or design described herein as “example” is not necessarily to be construed as preferred or advantageous over other aspects or designs. Rather, use of the word “example” is intended to present concepts in a concrete fashion. As used in this application, the term “or” is intended to mean an inclusive “or” rather than an exclusive “or. ” That is, unless specified otherwise, or clear from context, “X includes A or B” is intended to mean any of the natural inclusive permutations. That is, if X includes A; X includes B; or X includes both A and B, then “X includes A or B” is satisfied under any of the foregoing instances. In addition, the articles “a” and “an” as used in this application and the appended claims may generally be construed to mean “one or more” unless specified otherwise or clear from context to be directed to a singular form. Moreover, use of the term “an implementation” or “one implementation” or “an embodiment” or “one embodiment” throughout is not intended to mean the same implementation or embodiment unless described as such. The terms “first,” “second,” “third,” “N^{th},” etc. as used herein are meant as labels to distinguish among different elements and may not necessarily have an ordinal meaning according to their numerical designation. When the term “about,” “substantially,” or “approximately” is used herein, this is intended to mean that the nominal value presented is precise within ±2%, ±5%, ±7%, ±10%, ±12%, ±15%, ±17%, or ±20%.

For simplicity of explanation, methods herein are depicted and described as a series of acts or operations. However, acts in accordance with this disclosure may occur in various orders and/or concurrently, and with other acts not presented and described herein. Furthermore, not all illustrated acts may be required to implement the methods in accordance with the disclosed subject matter. In addition, those skilled in the art will understand and appreciate that the methods could alternatively be represented as a series of interrelated states via a state diagram or events. Additionally, it should be appreciated that the methods disclosed in this specification are capable of being stored on an article of manufacture to facilitate transporting and transferring such methods to computing devices. The term article of manufacture, as used herein, is intended to encompass a computer program accessible from any computer-readable device or storage media.

In additional embodiments, one or more processing devices for performing the operations of the above described embodiments are disclosed. Additionally, in embodiments of the disclosure, a non-transitory computer-readable storage medium stores instructions for performing the operations of the described embodiments. Also in other embodiments, systems for performing the operations of the described embodiments are also disclosed.

It is to be understood that the above description is intended to be illustrative, and not restrictive. Other embodiments will be apparent to those of skill in the art upon reading and understanding the above description. The scope of the disclosure may, therefore, be determined with reference to the appended claims, along with the full scope of equivalents to which such claims are entitled.

What is claimed is:

1. A wireless network access device comprising:
a wireless local area network (WLAN) radio configured to transmit and receive on a first frequency band, a second frequency band, and a third frequency band;
a memory device that stores instructions; and
a processing device operatively coupled to the memory device and WLAN radio, wherein the processing device is configured to execute the instructions to:
send a signal on the first frequency band and the second frequency band to a first neighboring access point (AP), the signal causing the first neighboring AP to update a reduced neighbor report information element (RNR IE) of a transmission to include information associated with the wireless network access device; and
connect to a wireless device on the third frequency band responsive to the wireless device receiving an updated transmission from the first neighboring AP, the updated transmission having an RNR IE comprising the information.

2. The wireless network access device of claim 1, wherein the updated transmission from the first neighboring AP is received by a second neighboring AP.

3. The wireless network access device of claim 1, wherein the information comprises a public action frame, the public action frame comprising:
an operating class;
an operating channel;
a basic service set identifier (BSSID); and
a service set identifier (SSID).

4. The wireless network access device of claim 3, wherein the operating class is associated with the third frequency band.

5. The wireless network access device of claim 1, wherein the information comprises a private action frame, the private action frame further comprising:
an operating class associated with the third frequency band;
an operating channel associated with the third frequency band and the operating class;
a BSSID;
a SSID; and
a proprietary protocol.

6. The wireless network access device of claim 1, wherein the first frequency band comprises frequencies from 2.400 gigahertz (GHz) through 2.4835 GHz.

7. The wireless network access device of claim 1, wherein the second frequency band comprises frequencies from 5.150 GHz through 5.825 GHz.

8. The wireless network access device of claim 1, wherein the third frequency band comprises frequencies from 5.925 GHz through 7.125 GHz.

9. The wireless network access device of claim 1, wherein the transmission from the first neighboring AP is one of a beacon frame or a probe response.

10. A method of operating a wireless network access device configured to transmit and receive on a first frequency band, a second frequency band, and a third frequency band, the method comprising:
sending a signal on the first frequency band and the second frequency band to a first neighboring access point (AP), the signal causing the first neighboring AP to update a reduced neighbor report information element (RNR IE) of a transmission to include information associated with the wireless network access device; and
connecting to a wireless device on the third frequency band responsive to the wireless device receiving an updated transmission from the first neighboring AP, the updated transmission having an RNR IE comprising the information.

11. The method of claim 10, wherein the updated transmission from the first neighboring AP is received by a second neighboring AP.

12. The method of claim 10, wherein the information comprises a public action frame, the public action frame comprising:
an operating class associated with the third frequency band;
an operating channel associated with the third frequency band and the operating class;
a basic service set identifier (BSSID); and
a service set identifier (SSID).

13. The method of claim 10, wherein the first frequency band comprises frequencies from 2.400 gigahertz (GHz) through 2.4835 GHz.

14. The method of claim 10, wherein the second frequency band comprises frequencies from 5.150 GHz through 5.825 GHz.

15. The method of claim 10, wherein the third frequency band comprises frequencies from 5.925 GHz through 7.125 GHz.

16. A system comprising:
a wireless device;
a wireless network access device configured to transmit and receive on a first frequency band, a second frequency band, and a third frequency band; and
one or more neighboring access points (APs) comprising a first neighboring AP, the first neighboring AP configured to:
receive a request from the wireless device on the first frequency band or the second frequency band;
receive a signal on the first frequency band or the second frequency band from the wireless network access device;
update a reduced neighbor report information element (RNR IE) of a transmission to include information associated with the wireless network access device; and
send an updated transmission to the wireless device, the updated transmission having an RNR IE comprising the information, wherein sending the updated transmission causes the wireless device to connect to the wireless network access device on the third frequency band.

17. The system of claim 16, wherein the information comprises a public action frame, the public action frame comprising:
an operating class associated with the third frequency band;
an operating channel associated with the third frequency band and the operating class;
a basic service set identifier (BSSID); and
a service set identifier (SSID).

18. The system of claim 16, wherein the first frequency band comprises frequencies from 2.400 gigahertz (GHz) through 2.4835 GHz.

19. The system of claim 16, wherein the second frequency band comprises frequencies from 5.150 GHz through 5.825 GHz.

20. The system of claim 16, wherein the third frequency band comprises frequencies from 5.925 GHz through 7.125 GHz.
